(19) United States
(12) Patent Application Publication
(10) Pub. No.: US 2004/0125611 A1
(43) Pub. Date: Jul. 1, 2004

(54) Driving aid for marking track of motor vehicle on road

(76) Inventor: Philip Pedley, Mineral Wells, TX (US)

Correspondence Address: JACK LO, 617 VIEWRIDGE DRIVE, PACIFICA, CA, 94044

(21) Appl. No.: 10/334,420

(22) Filed: Dec. 31, 2002

(51) Int. Cl. B60R 1/12; B60Q 1/12

(52) U.S. Cl. 362/494; 362/37; 362/523

(57) ABSTRACT

A motor vehicle light is comprised of a high intensity lamp for attaching to a motor vehicle, such as to a side mounted rear view mirror. The lamp includes optics for focusing a light beam into a small spot on the road in front of the vehicle. The lamp includes a hinge for being pivoted to direct the light spot for marking the track of the vehicle to help the driver position the vehicle within the lane. In a second embodiment, the lamp is linked to the steering apparatus of the vehicle for simultaneous movement so as to mark the track of a rear wheel during a turn.

### BACKGROUND OF THE INVENTION

1. Field of the Invention

The invention broadly relates to lamps attached to motor vehicles.

2. Prior Art

The driver of a motor vehicle must be able to accurately judge the width and positions of the vehicle's tracks to avoid incursions into adjacent lanes. Some drivers of wide vehicles, such as large trucks, have difficulty judging the width of their vehicles' tracks. Some drivers of passenger vehicles have the same problem when they tow wide trailers. Although motor vehicle headlights project beams onto the road ahead of the vehicle, the beams are widely divergent and only illuminate the space and objects in front of the vehicle. Headlight beams produce light patterns that are too indistinct for marking the tracks. They are also not bright enough to be seen during daylight.

### BRIEF SUMMARY OF THE INVENTION

Accordingly, an object of the present driving aid is to project a sharp light spot on the road ahead of the vehicle to indicate the projected track of the vehicle, that is, where the wheels will be as the vehicle travels forward, so as to enable the driver to accurately position the vehicle within the lane. Another object is to be adjustable for tracks of different widths. Still another object is to indicate the track of a rear wheel of a long wheel based vehicle when making turns.

The present driving aid is comprised of a high intensity lamp for attaching to a motor vehicle, such as to the front of a side mounted rear view mirror. The lamp includes optics for focusing a light beam into a small spot on the road in front of the vehicle. The lamp includes a hinge for being pivoted to direct the light spot for marking the track of the vehicle to help the driver position the vehicle. In a second embodiment, the lamp is linked to the steering apparatus of the vehicle for simultaneous movement so as to mark the track of a rear wheel during turns.

### BRIEF DESCRIPTION OF THE SEVERAL VIEWS OF THE DRAWING

FIG. 1 is a side perspective view of the present driving aid.

FIG. 2 is a side perspective view thereof pivoted to a different position.

FIG. 3 is a front perspective view thereof marking the track of a vehicle.

FIG. 4 is a rear perspective view thereof from inside the vehicle.

FIG. 5 is a second embodiment thereof marking the track of a rear wheel.

### DRAWING REFERENCE NUMERALS

10. Lamp
11. Vehicle
12. Rear View Mirror
13. Optics
14. Light Beam
15. Pivot
16. Trailer
17. Track
18. Light Spot
19. Rear View Mirror
20. Vehicle
21. Linkage
22. Steering Apparatus
23. Track
24. Rear Wheel

### DETAILED DESCRIPTION OF THE INVENTION

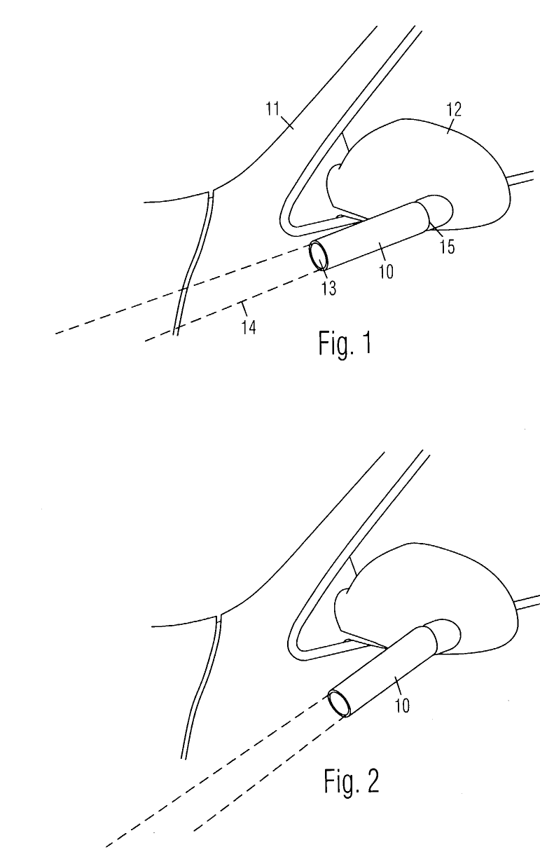

FIGS. 1-2:

A first embodiment of the present driving aid is shown in a side perspective view in FIG. 1. It is comprised of a high intensity lamp 10 for attaching to a motor vehicle 11. As an example, lamp 10 is attached to a side mounted rear view mirror 12. Lamp 10 includes optics 13 for focusing light from within into a generally parallel beam 14. Lamp 10 also includes a hinge 15 for directing beam 14 at a selected point on the road ahead of vehicle 11. Beam 14 is preferably colored, such as an amber color, but it may be of another color. Lamp 10 may be any type of high intensity light source that produces a narrow beam, such as a stage lamp, a laser, etc. Lamp 10 is shown in FIG. 2 pivoted to another position.

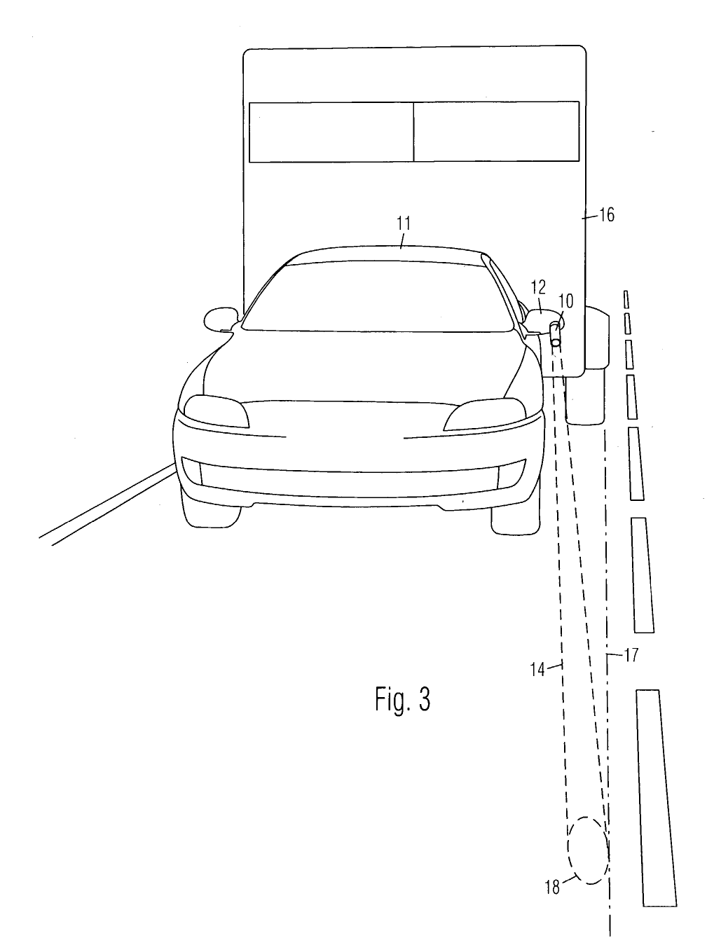

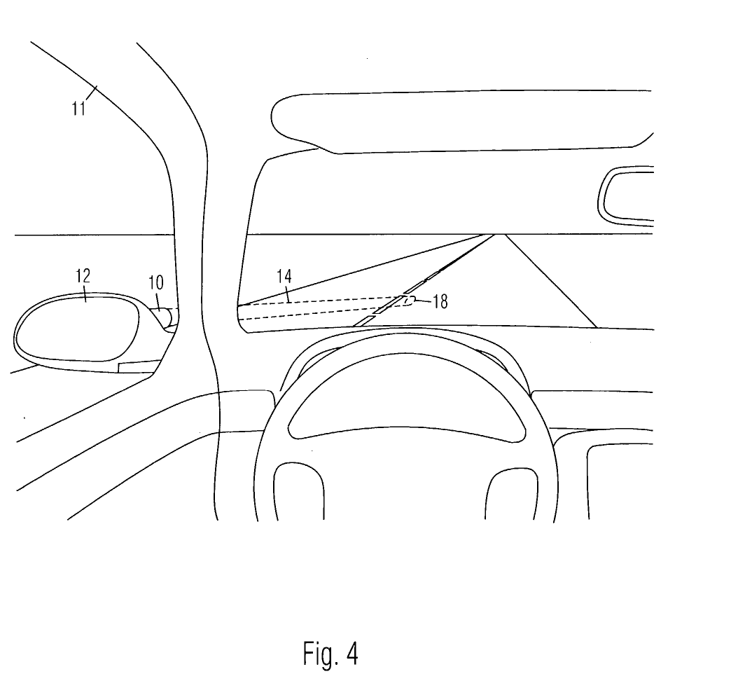

FIG. 3:

Lamp 10 is shown attached to rear view mirror 12 on vehicle 11 in FIG. 3. In this example, lamp 10 is shown as an add-on to mirror 12, but it may be incorporated within mirror 12. In this example, vehicle 11 includes a trailer 16 with a track 17 when vehicle 11 is going straight. Lamp 10 is adjusted to direct light beam 14 to a position in front of vehicle 11 and produce a small light spot 18 on the road that marks projected track 17. Light spot 18 is preferably about 4 inches to 8 inches wide. Lamp 10 is powerful enough to make spot 18 bright enough to be clearly visible even in daylight. Spot 18 is thus arranged to help the driver position vehicle 11 laterally. Since lamp 10 is directed at the road in front of vehicle 11, it is angled low enough to avoid blinding oncoming drivers. Lamp 10 may be pivoted to mark the track of any motor vehicle or trailer of any width.

Lamp 10 may be attached to any type of motor vehicle, including passenger cars, trucks, and tractor-trailers. As an example, lamp 10 is shown mounted on the left side of vehicle 11. An additional lamp may be mounted on the right side of vehicle 11. Alternatively, each lamp may be mounted at another position on vehicle 11, or a single lamp may be mounted at the front of vehicle 11 for being directed to either the left or the right side of the road.

FIG. 4:

Lamp 10 is shown in FIG. 4 as seen from inside vehicle 11. Light beam 14 is projected by lamp 10 at the road in front of vehicle 11 to mark the projected track of the vehicle. Light spot 18 shows the driver exactly where the track of the vehicle will be on the road to help the driver stay within the lane.

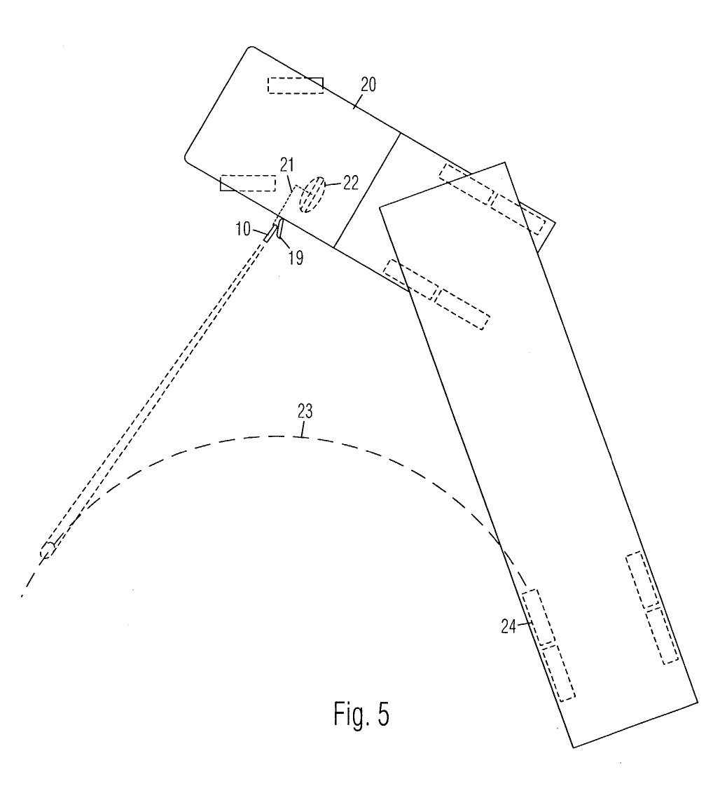

FIG. 5:

In a second embodiment shown in FIG. 5, lamp 10 is attached to a side mounted rear view mirror 19 of a long vehicle 20, such as a tractor-trailer. Alternatively, lamp 10 may be mounted to another part of vehicle 20. Lamp 10 is connected by a linkage 21 to a steering apparatus 22 of vehicle 20, and is pivoted to simultaneously turn in the same direction as steering apparatus 22. Linkage 21 may pivot lamp 10 purely mechanically, such as with cables, or electromechanically, such as with actuator motors. Linkage 21 is arranged to pivot lamp 10 to mark a track 23 of a rear wheels 24, which is especially useful during a tight turn.

Although the foregoing description is specific, it should not be considered as a limitation on the scope of the invention, but only as an example of the preferred embodiment. Many variations are possible within the teachings of the invention. Therefore, the scope of the invention should be determined by the appended claims and their legal equivalents, not by the examples given.

I claim:

1. A motor vehicle driving aid, comprising:
a lamp for attaching to a motor vehicle, wherein said lamp produces a generally parallel light beam that positions a light spot on a road ahead of said motor vehicle for marking a projected track of said motor vehicle.

2. The motor vehicle driving aid of claim 1, wherein said lamp is arranged to provide said light spot with a width of about 4 inches to 8 inches.

3. The motor vehicle driving aid of claim 1, wherein said lamp includes a hinge for being pivoted to adjustably align said light spot with said projected track of said vehicle.

4. The motor vehicle driving aid of claim 1, wherein said light spot is colored.

5. A motor vehicle driving aid, comprising:
a motor vehicle; and
a lamp attached to said motor vehicle, wherein said lamp produces a generally parallel light beam that positions a light spot on a road ahead of said motor vehicle for marking a projected track of said motor vehicle.

6. The motor vehicle driving aid of claim 5, wherein said lamp is arranged to provide said light spot with a width of about 4 inches to 8 inches.

7. The motor vehicle driving aid of claim 5, wherein said lamp includes a hinge for being pivoted to adjustably align said light spot with said projected track of said vehicle.

8. The motor vehicle driving aid of claim 5, wherein said light spot is colored.

9. The motor vehicle driving aid of claim 5, wherein said lamp is attached to a side mounted rear view mirror on said motor vehicle.

10. A motor vehicle driving aid, comprising:
a lamp for attaching to a motor vehicle, wherein said lamp produces a generally parallel light beam that positions a light spot on a road adjacent said motor vehicle; and
a linkage connecting said lamp to a steering wheel of said motor vehicle, wherein said lamp is pivoted to simultaneously turn with said steering wheel to mark a projected track of a rear wheel of said motor vehicle.

11. A method for helping a driver to maintain a motor vehicle within a lane on a road, comprising:
directing a generally parallel light beam ahead of said motor vehicle to produce a light spot on said road; and
aligning said light spot with a track of said vehicle.

12. The method of claim 11, further including providing said light spot with a width of about 4 inches to 8 inches.
